(19) United States
(12) Patent Application Publication
(10) Pub. No.: US 2004/0067353 A1
(43) Pub. Date: Apr. 8, 2004

(54) Self-foaming core reinforcement for laminate applications

(76) Inventors: Thomas S. Miller, Granville, OH (US); William G. Hager, Westerville, OH (US)

Correspondence Address: OWENS CORNING, 2790 COLUMBUS ROAD, GRANVILLE, OH, 43023, US

(21) Appl. No.: 10/266,348

(22) Filed: Oct. 8, 2002

(51) Int. Cl. B32B 3/26; B29C 65/00; B32B 9/00

(52) U.S. Cl. 428/304.4; 428/318.4; 264/41

(57) ABSTRACT

A foam core structural laminate material is made by reacting a polymer matrix material with a blowing agent contained on a dry fiber preform within a mold. The laminate material formed therefore has a fiber reinforced core material and a foamed outer region. To add toughness to the laminate material, a glass fiber matting may be introduced to the mold such that the dry fiber preform is centrally located within the mold and the matting is located along the outer periphery.

### TECHNICAL FIELD AND INDUSTRIAL APPLICABILITY OF THE INVENTION

The present invention relates generally to laminate materials and more specifically to self-foaming core reinforcements for structural reinforced laminate applications.

### BACKGROUND OF THE INVENTION

Many attempts have been made to create structural laminates particularly of foamed resins to be used as low density thermal insulation or as wall or ceiling panels. Often, the foamed resins are backed with a textile or fabric layer that adds strength to the laminate. These structural laminates may be used in a wide variety of applications, including automotive applications such as truck bed covers and interior trim boxes.

The method for preparing foam-filled sheet products consists of filling a fibrous matting with a foaming mixture in a substantially inactive state. The foaming material is expanded in situ within the fibrous matting and the foam is expanded away from each other in a direction toward the broad faces of the sheet being formed. The expanded foam is then cured. Typically, the method further involves compressing the fibrous matting with the foaming material thereon and controlling the compression so that its expansion is caused by the expanding foaming mixture rather than the inherent resiliency of the compacted fibrous matting and to perform the method in a continuous operation or in a batch molding process.

Presently available foam core structures suffer from many common problems. For example, the reinforcement is controlled by the foaming polymer matrix material, not by the reinforcing material, and thus the foam core created must be pre-formed or shaped to fit the part. Also, the formed reinforcement has a central core area that does not contain the reinforcing fibers and therefore may lack in structural properties and may lack in the ability to transmit shear and compressive loads. Also, existing foamed composites do not have a high density structural skin when molded, but instead maintain a constant density throughout.

It is therefore highly desirable to provide a foam core reinforcement material that overcomes many of the problems typically found with self-foaming laminate materials.

### SUMMARY OF THE INVENTION

A simple, cost effective composite laminate structure having a structural foam core reinforcement material. The structural foam sandwiches made according to the present invention offer many important advantages to traditional foam core sandwiches. For example, the foam core sandwich is controlled by the reinforcement material input, not by the inserted foam material. Also, the foam core sandwiches are created in situ. Further, the foam core that is created does not have to be pre-formed or shaped to fit the laminate part, the core will expand to fill complex shapes. In addition, the foaming is controlled by the reinforcement material input, not the matrix polymer, so controlled location of the foaming within the preform and resulting laminate structure is possible. Finally, the foam core is reinforced by the fibrous mat, thereby adding additional structural properties and results in a laminate material that is better able to transmit shear and compressive loads.

One preferred method for making the product comprises first inserting a dry fiber preform coated with a blowing agent in an injection-compression mold. The mold is then partially closed and a matrix polymer is injected into the mold. The mold continues to close and push the matrix material throughout the preform. Press tonnage is used to briefly ensure consolidation and wet-out of the matrix polymer into the reinforcement fibers. The blowing agent reacts with the matrix polymer to produce a gas that creates a foam layer. The mold is then partially opened several millimeters to allow the self-foaming layer to expand and increase the thickness of the part. After an appropriate cure cycle, the mold is opened and the part removed. Thus, a part is formed having a reinforcement mat middle region and a foamed outer region.

In another preferred embodiment, at least one additional matting material layer is added to the surface of the mold. The resultant reinforced laminate material has a similar foam core sandwich as above but also has a toughened outer surface due to the presence of the matting material. The matting material preferably does not contain the blowing agent, thereby limiting the expansion of foam to the mold surfaces. However, in other preferred embodiments, a layer of the preform material containing the blowing agent may replace one or both of the matting layers.

Other objects and advantages of the present invention will become apparent upon considering the following detailed description and appended claims, and upon reference to the accompanying drawings.

### BRIEF DESCRIPTION OF THE DRAWINGS

FIG. 1 illustrates a foam core laminate material according to a preferred embodiment of the present invention;

FIG. 2 illustrates a preferred processing line for making the self foaming core reinforcement material of claim 1; and

FIG. 3 illustrates a foam core laminate material made according to another preferred embodiment of the present invention.

### DETAILED DESCRIPTION AND PREFERRED EMBODIMENTS OF THE INVENTION

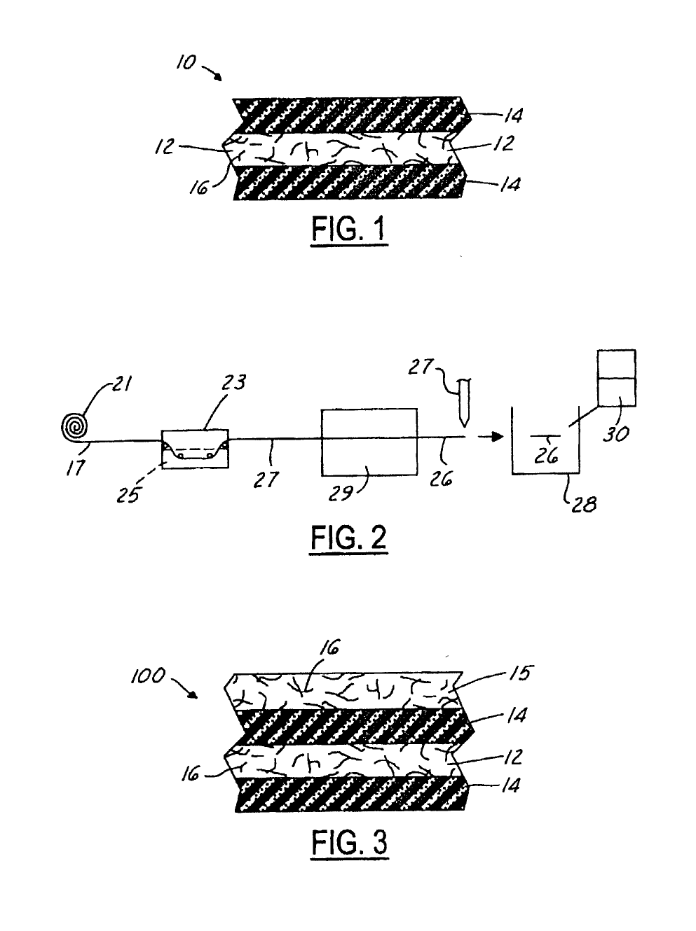

FIG. 1 illustrates a laminate structure 10 according to a preferred embodiment of the present invention a low density composite fiber reinforced foam core 12 that is formed between a pair of foamed regions 14. The low density composite fiber reinforced foam core 12 comprises a plurality of reinforcing fibers 16 interspersed within a foam material 18.

The foam material formed within the core 12 and comprising the entire foamed regions 14 is the reaction product of a blowing agent (shown as 25 in FIG. 2) reacting with a matrix polymer material (shown as 30 in FIG. 2). The resultant foam material within the core 12 and foam regions 14 is formed due to the release of gas, typically carbon dioxide, that expands within the reacted product of the blowing agent 25 and polymer material 30. The method for forming the laminate structure 10 is described below in FIG. 2.

The laminate structure 10 formed can be used in a wide variety of applications requiring strength, the ability to transmit shear and compressive loads, weight reduction, and cost effectiveness in terms of manufacturing costs and raw material costs as compared with known laminate materials and structural systems. Specific applications, contemplated for the laminate structure 10 include structural and semi-structural composite structure systems. For example, automotive structural applications where the laminate structure 10 could be used include but are not limited to load floors, interior trim, truck tailgate structures, and seat bases. Examples of non-structural automotive applications could include door trim, rear shelf package trays, and sunroof covers. The laminate structure 10 could also be used as a selective reinforcement in roving-based LFI (long fiber injection) or SRIM (structural reinforced injection molding) preform applications.

FIG. 2 illustrates one preferred process for making the laminate structure 10 of FIG. 1. A fiber matting 17 is unrolled from a creel 21 and dipped into an immersion bath 23 containing a blowing agent 25 to form the coated matting structure 27. Of course, other application methods known to persons of skill in the art could be used to apply the blowing agent to the matting 17. For example, the blowing agent 25 could be applied using a curtain coater or roll coater.

The matting 17 comprises a plurality of reinforcing fibers 16 bound together with a binder material. One preferred matting 17 is Owens Corning's M8610 continuous filament mat, which utilizes e-type glass as the reinforcing fiber 16.

Of course, other types of reinforcing fibers 16 that may be used include, but are not limited to, s-type glass fibers, ECR-type glass fibers such as Owens Corning's Advantex® fibers, carbon fibers, aramid fibers, other polymer fibers and natural fibers may be used. These fibers 16 could be in many forms, including continuous rovings and chopped strands.

The binder material preferably is composed a sizing composition that prevents interfilament abrasion and fuzzing of the fibers 16. The sizing composition preferably contains a silane-coupling agent. The binder material also has a film former, such as an unsaturated polyester film former, designed to bind the fibers together to form the matting 17. The binder material may also have other additives well known in the art, including but not limited to additives such as anti-microbial agents and surfactants.

The blowing agent 25 comprises an inorganic or organic material having functional groups that can react with a complimentary reactive component within the matrix polymer resin (shown as 30 below) to produce a gas that creates the foam structure 12, 14. One preferable blowing agent 25 is a polymer based on polyacrylic acid (PAA) such as Acumer 1510, available from Rohm & Haas. Another is polyvinyl acetate. However, other blowing agents 25 that may be used include but are not limited to baking powder, ammonium carbonate (cellular or sponge rubber), sodium bicarbonate, azo compounds, and pentane (used in expanded polystyrene).

The coated matting structure 27 is removed from the bath 23 placed in a drying oven 29 heated to between 120 and 150 degrees Celsius to remove water and dry the blowing agent 25 onto the matting 17, therein forming a dry fiber preform 26. The dry fiber preform 26 is chopped to a suitable size using a chopper 27 and is then placed into a mold 28, preferably an injection compression mold 28. The mold 28 is held constant at between 150 and 210 degrees Fahrenheit and at a pressure between approximately 50 and 100 pounds per square inch. The mold 28 is then partially closed to within approximately ¼ to 1 inch from fully closed. A matrix polymer material 30 is introduced as a liquid to the mold 28 at between 60 and 150 degrees Fahrenheit. Press tonnage is used to briefly ensure consolidation and wet-out of the matrix polymer material 30 into the dry fiber preform 26. The reactive component of the matrix polymer material 30 reacts with the corresponding reactive component of the blowing agent 25 to form a reacted polymer foam and gas that form the higher density outer foam regions 14 and the low density composite fiber reinforced foam core 12.

The mold 28 is then partially opened several millimeters to allow the foamed region 14 to expand away from the core 12, and increase the thickness of the structure 10 to a desired thickness. The reacted polymer the core 12 expands as well as the mold 28 is partially opened.

In the preferred embodiment of the present invention, the matrix polymer material 30 is a urethane material having reactive isocyanate groups. One preferred matrix polymer is Baydur 426, available from Bayer, which reacts with the preferred blowing agent 25, here Acumer 1510, to form amide linkages and release carbon dioxide.

Of course, where other blowing agents 25 other than PAA are used, the composition of the matrix polymer material 30 may change in order to contain reactive components that react with the blowing agent 25 to form a foam structure as one of skill in the art would appreciate.

In an alternative process, the matrix polymer material 30 is injected while the mold 28 is closing, as opposed to after the mold 28 has closed as described above, with the process continuing onto the curing cycle as described below.

After an appropriate cure cycle, typically between 60 seconds and 5 minutes, the mold 28 is opened and the laminate structure 10 removed. The cure cycle is dependent upon the composition of the blowing agent 25 and matrix polymer material 30 used, but is typically between one minute and five minutes. A post cure cycle may also be required after the laminate structure 10 ejection from the mold 28 to ensure complete cure.

In the preferred embodiment containing Acumer 1510 as the blowing agent 25 and Baydur 426 as the matrix polymer material 30, the mold temperature is maintained at between 75 and 100 degrees Celsius, and more preferably at approximately 85-90 degrees Celsius, for approximately 1-5 minutes to ensure adequate cure of the resulting laminate structure 10.

The ability to control the specific location of the low density composite fiber reinforced foam core 12 within the laminate structure 10 is a powerful feature of the present invention. With this feature, localized reinforcement zones having the foam core 12 where load, strength or shear conditions exist can be created easily while less expensive non-structural foamed regions can be formed similar to the foamed region 14 of FIG. 1.

As one skilled in the art would appreciate, any number of laminate material 10 configurations may be produced in accordance with the present invention as a function of the location of the fiber preform 26 within the mold 28 and as a function of how far the mold 28 is opened after injection of the matrix polymer material 30. Thus, depending upon the application, laminate materials 10 having varying strength, shear and compressive load characteristics are possible.

Further, by varying the size of the fiber preform 26, or by varying the amount of opening within the mold 28, the ratio of foam core 12 to foamed region 14 may be varied depending upon the application, these same features may be further modified.

Finally, by simply changing the shape or size of the mold 28, laminate materials 10 having foam core 12 regions and foamed regions 14 may be made in a potentially infinite variety of shapes and sizes.

In alternative preferred embodiments not shown, the blowing agent 25 could also be added as an in-line sizing process, in which the blowing agent 25, silanes and film formers are blended with water and applied to the fibers 16 using a typical roll applicator or AS-4 slot applicator. This would negate the step of applying the blowing agent 25 through the immersion bath 23 as described above.

Alternatively, the blowing agent 25 may be added in a secondary, off-line coating operation similar to a string binder process. In this process, the blowing agent 25 is combined with a film former or mat binder as a string binder polymer. The string binder and plurality of reinforcing fibers 16 are mixed. The mixture is then placed in a curing oven that melts the string binder onto the reinforcing fibers, thereby forming the dry glass fiber preform 26. The preform 26 is removed from the curing oven and is available to be processed as described above.

Referring now to FIG. 3, another preferred laminate structure 100 of the present invention is shown having a low density composite fiber reinforced foam core 12 that is formed between a pair of foamed regions 14 as shown in FIG. 1. However, in this embodiment, the foamed regions 14 are formed between the core 12 and an outer higher density reinforced region 15.

The outer higher density reinforced region 15 is formed in a similar manner to the foam core 12 and comprises a foam material and a plurality of reinforcing fibers 16. The foam material is the reaction product of the matrix polymer material 30 and blowing agent 25 contained on the dry fiber preform 26 as described above. The reinforced region 15 provides the laminate structure 100 with a tougher surface as compared with the laminate structure 10 of FIG. 1 due to the presence of the reinforcing fibers near a visible outer surface.

To form the outer higher density structural reinforced region 15, an additional matting 17 is placed above or below the preform 26 contained within the mold 28. Alternatively, if more than one reinforced surface is desired in the laminate structure 100, a layer of matting 17 is placed both above and below the fiber preform 26 within the mold 28. The matrix polymer material 30 is introduced as described above with respect to FIG. 2, thereby forming the foam core 12 and foamed regions 14. Additionally, a portion of the foamed material 14 seeps within the matting 17 as the mold 28 is opened, therein forming the outer higher-density structural reinforced regions 15. If additional foaming is desired, the matting 17 can be replaced with a second layer of preform 26.

While the invention has been described in terms of preferred embodiments, it will be understood, of course, that the invention is not limited thereto since modifications may be made by those skilled in the art, particularly in light of the foregoing teachings.

What is claimed is:

1. A laminate material comprising:
a fiber reinforced core material; and
a foamed region formed around said fiber reinforced core material.

2. The laminate material of claim 1, wherein said fiber reinforced core material and said foamed region are formed from the chemical reaction between a blowing agent contained on a dry fiber preform and a matrix polymer material.

3. The laminate material of claim 2, wherein said dry fiber preform comprises:
a matting comprising a plurality of reinforcement fibers bound together with a binder material; and
a blowing agent coupled to a portion of said binder material.

4. The reinforcement material of claim 3, wherein said plurality of reinforcing fibers comprises a plurality of fiber bundles, a plurality of chopped reinforcing fibers, or a plurality of fiber strands.

5. The reinforcement material of claim 3, wherein said plurality of reinforcing fibers comprises e-type glass fibers, s-type glass fibers, ECR-type glass fibers carbon fibers, aramid fibers, or natural fibers.

6. The reinforcement material of claim 3, wherein said blowing agent is a component of said binder material.

7. The reinforcement material in claim 3, wherein said blowing agent is selected from the group comprising polyacrylic acid, polyvinyl acetate, baking powder, cellular sponge rubber ammonium carbonate, cellular ammonium carbonate, sodium bicarbonate, azo compounds, pentane, and mixtures thereof.

8. The reinforcement material of claim 3, wherein said blowing agent comprises Acumer 1510, available from Rohm & Haas.

9. The reinforcement material of claim 2, wherein said matrix polymer resin comprises a polyurethane matrix polymer resin.

10. The reinforcement material of claim 9, wherein said polyurethane matrix polymer resin comprises Baydur 426, available from Bayer.

11. The reinforcement material of claim 1 further comprising an outer higher-density reinforced region, wherein one of said foamed regions is between said outer higher-density reinforced region and said fiber reinforced core material.

12. The reinforcement material of claim 1 further comprising a pair of outer higher-density structural reinforced regions, wherein each of said foamed regions is between a respective one of said outer higher-density structural reinforced region and said fiber reinforced core material.

13. A method for forming a laminate material having a self foaming core reinforcement comprising:
providing a dry fiber preform, said dry fiber preform comprising a plurality of reinforcing fibers and a blowing agent;
introducing said dry fiber preform to a mold;
introducing a matrix polymer material within said mold such that said matrix polymer material is consolidated and wetted out within said dry fiber preform, said matrix polymer resin capable of reacting with said blowing agent to form a low density composite reinforced foam core and a high density foamed outer region;
partially opening said mold to allow said high density foamed outer region to expand away from said low density composite reinforced foam core;
curing said high density foamed outer region and said low density composite reinforced foam core to form the laminate material; and
removing the laminate material from said mold.

14. The method of claim 13, wherein providing a dry fiber preform comprises:
providing a matting, said matting comprising a plurality of reinforcement fibers bound together with a binder material;
applying a blowing agent to said matting;
drying said blowing agent onto said matting to form a dry fiber preform.

15. The method of claim 14, wherein providing a matting comprises:
forming a binder material within an applicator, said binder material comprising a mixture a sizing composition and a film former;
applying said binder material to a plurality of reinforcing fibers using said applicator to bind together said plurality of reinforcing fibers; and
drying said binder material onto said plurality of fibers to form a matting.

16. The method of claim 13, wherein forming a dry fiber preform comprises:
mixing a blowing agent, a sizing composition and a film former together in an immersion bath to form a binder material;
introducing a plurality of reinforcing fibers to said immersion bath, wherein said binder material saturates said plurality of reinforcing fibers; and
drying said binder material onto said plurality of reinforcing fibers to bind together said plurality of reinforcing fibers to form a dry fiber preform.

17. The method of claim 13, wherein forming a dry fiber preform comprises:
forming a string binder polymer having a blowing agent;
mixing said string binder polymer with a plurality of reinforcing fibers; and
heating said string binder polymer and said plurality of reinforcing fibers such that said string polymer binder binds together said plurality of reinforcing fibers to form a dry fiber preform.

18. A method for forming a laminate material having a self foaming core reinforcement and at least one tough outer surface comprising:
providing a dry fiber preform, said dry fiber preform comprising a plurality of reinforcing fibers and a blowing agent;
providing a matting, said matting comprising a second plurality of reinforcing fibers bound together with a binder material;
introducing said dry fiber preform and said matting to a mold;
introducing a matrix polymer material within said mold such that said matrix polymer material is consolidated and wetted out within said dry fiber preform and said matting, said matrix polymer resin capable of reacting with said blowing agent to form a low density composite reinforced foam core and a high density foamed outer region and an outer low-density reinforced region;
partially opening said mold to allow said high density foamed outer region to expand away from said low density composite reinforced foam core;
curing said high density foamed outer region and said low density composite reinforced foam core and said outer low-density reinforced region to form the laminate material; and
removing the laminate material from said mold.

19. The method of claim 18 further comprising introducing a second matting to said mold such that said dry fiber preform is contained between said matting and said second matting.

20. The method of claim 18, wherein said matting comprising a second plurality of reinforcing fibers bound together with a binder material and wherein said matting has a blowing agent dried upon said binder material.
